(19) United States
(12) Patent Application Publication
(10) Pub. No.: US 2017/0098817 A1
(43) Pub. Date: Apr. 6, 2017

(54) DISTRIBUTING CONDUCTIVE CARBON BLACK ON ACTIVE MATERIAL IN LITHIUM BATTERY ELECTRODES

(71) Applicant: GM GLOBAL TECHNOLOGY OPERATIONS LLC, DETROIT, MI (US)

(72) Inventors: Zhiqiang Yu, Shanghai (CN); Meiyuan Yu, Shanghai (CN); Xiaochao Que, Shanghai (CN); Jianyong Liu, Shanghai (CN)

(21) Appl. No.: 15/311,862

(22) PCT Filed: May 21, 2014
(86) PCT No.: PCT/CN2014/077969

§ 371 Date: Nov. 17, 2016

(51) Int. Cl. H01M 4/04; H01M 4/1391; H01M 10/0525; H01M 4/505; H01M 4/62; H01M 4/66; H01M 4/131; H01M 4/525

(52) U.S. Cl. CPC H01M 4/0404; H01M 4/131; H01M 4/1391; H01M 4/525; H01M 4/505; H01M 4/623; H01M 4/625; H01M 4/661; H01M 10/0525; H01M 2004/028

(57) ABSTRACT

Improved electrodes for lithium battery cells are made by coating micrometer-size anode or cathode material particles with aggregates of smaller conductive carbon black particles in two mixing steps, using a liquid dispersant in each step for the mixing particles. A first portion of carbon black is vigorously mixed with the electrode particles to coat their surfaces with the smaller carbon black particles. A second portion of carbon black is less vigorously mixed with the initially coated electrode particles to form clusters of carbon black particles at the interfaces of the previously coated electrode particles. This two-step distribution of carbon black particles increases the power capacity of the porous electrode layer bonded to its current collector and increases the life of its battery cell.

### TECHNICAL FIELD

This invention pertains to the preparation of particulate active electrode materials for use in lithium battery cells. Aggregates of small carbon black particles are mixed with particles of an electrode material in liquid dispersions in two predetermined, varied intensity mixing steps to obtain (i) a uniform distribution of conductive carbon particles on the surfaces of the active electrode material particles and (ii) a porous interconnected network of conductive carbon particles between the active material particles. When the prepared carbon black-coated electrode material particles are bonded to a current collector, the resulting electrode provides both higher power per unit weight of electrode material and longer life.

### BACKGROUND OF THE INVENTION

Assemblies of lithium-ion battery cells are finding increasing applications in providing motive power in automotive vehicles. Lithium-sulfur cells are also candidates for such applications. Each lithium-ion cell of the battery is capable of providing an electrical potential of about three to four volts and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

In these automotive applications, each lithium-ion cell typically comprises a negative electrode layer (anode, during cell discharge), a positive electrode layer (cathode, during cell discharge), a thin porous separator layer interposed in face-to-face contact between parallel, facing, electrode layers, and a liquid, lithium-containing, electrolyte solution filling the pores of the separator and contacting the facing surfaces of the electrode layers for transport of lithium ions during repeated cell discharging and re-charging cycles. Each electrode is prepared to contain a layer of an electrode material, typically deposited as a wet mixture on a thin layer of a metallic current collector.

For example, the negative electrode material has been formed by depositing a thin layer of graphite particles, or lithium titanate particles, and a suitable polymeric binder onto one or both sides of a thin foil of copper which serves as the current collector for the negative electrode. The positive electrode also comprises a thin layer of resin-bonded, porous, particulate lithium-metal-oxide composition bonded to a thin foil of aluminum which serves as the current collector for the positive electrode. Thus, the respective electrodes have been made by dispersing mixtures of the respective binders and active particulate materials in a suitable liquid, depositing the wet mixture as a layer of controlled thickness on the surface of a current collector foil, and drying, pressing, and fixing the resin-bonded electrode particles to their respective current collector surfaces. The positive and negative electrodes may be formed on conductive metal current collector sheets of a suitable area and shape, and cut (if necessary), folded, rolled, or otherwise shaped for assembly into lithium-ion cell containers with suitable porous separators and a liquid electrolyte.

There remains a need for improved electrode compositions and methods of making them to further improve the life and power delivering capability of lithium battery cells.

### SUMMARY OF THE INVENTION

In accordance with embodiments of this invention, particles of active electrode materials for lithium battery cells are coated with smaller particles of carbon black for the purpose of improving electrochemical conductivity within and between the active material particles in the presence of a suitable lithium ion-containing electrolyte. The particles of electrode material may, for example, have representative particle sizes of about ten micrometers or, for example, in the range of about five to fifty micrometers. And, for example, particles of graphite or lithium titanate may be selected as negative electrode (anode) material or particles of lithium manganese nickel cobalt oxide may be used as positive electrode (cathode) material.

A first mixture of predetermined quantities of particulate aggregates of nanometer size particles of carbon black and of micrometer size particles of a selected electrode material is formed as dispersed particles in a predetermined amount of an aqueous or organic liquid. The particles of electrode material and the aggregates of carbon black particles may be of comparable size, but the individual carbon black particles are much smaller than the particles of electrode material.

The liquid dispersion of carbon black aggregates and electrode particles may be formed in a suitable mixing vessel, such as a generally round-sided, flat-bottom stainless steel mixing vessel. The combination of particles and liquid is mixed using a first predetermined mixing program (the parameters of which may be determined experimentally). For example, mixing may be performed in a selected mixing vessel with rotating mechanical mixing devices comprising a first set of mixing blades shaped and operated for relatively high viscous mixing and another set of mixing blades shaped and operated for less-viscous mixing.

In this first mixing step, the proportion of carbon black particles, the liquid content and viscosity of the dispersion of mixed particles, the nature or aggressiveness of stirring, and the time of stirring are controlled so as transform the contents of the mixing vessel into a first-stage product comprising the liquid dispersant and a mixture of particles characterized in that small clusters (e.g., 2-10 particles) of the smaller carbon black particles are all distributed generally uniformly on the surfaces of all of the larger particles of electrode material. The mixing step may be started with the materials at room temperature, but the temperature of the mixture tends to increase with the aggressive mixing of the relatively viscous materials and some cooling may be necessary or desirable.

A second portion of the same, or like, particulate aggregates of carbon black particles and additional liquid dispersant are then added to the first-stage mixture product in the mixing vessel. A second stage mixing operation is conducted in which the mixture is less viscous and mixing is less aggressive. Typically less heat is generated. Again, the processing parameters of this second mixing step are determined and practiced such that the added second batch of aggregates of carbon black particles are broken down and dispersed in clusters of carbon black particles between the particles of electrode material, which have their retained coating of smaller clusters of carbon black particles on their particle surfaces. In general, the clusters of carbon black particles between the particles of electrode material will contain more carbon black particles then the clusters of carbon black particles that coat the individual active electrode material particles. Again, the quantities of added carbon black particles and of added liquid, the operation of the mixing tools, and the duration and temperature of mixing are determined to produce the stated organization of electrode particles and carbon black particles.

If desired, a suitable amount of a polymeric binder material may be mixed with the liquid-dispersed mixture of electrode particles and carbon black particles. In a preferred embodiment, the binder is dissolved in the liquid dispersant and then deposited in the electrode particles during evaporation of the liquid at the completion of the mixing process.

The twice-coated electrode particles are removed from the mixing vessel and applied in a coextensive layer on a surface of a suitable current collector substrate for the intended electrode. The liquid dispersant is evaporated from the applied layer of electrode material and any binder is cured, if necessary, to bond the carbon black-coated electrode particles to each other and to the surface of the current collector strip or foil. But the first mixing step with the aggregates of carbon black and the second mixing step with the like aggregates of carbon black particles are performed so that the applied layer of electrode material particles comprises both a generally uniform coating of nanometer size carbon black particles on their surfaces and porous clusters of like carbon black particles in spaces between the closely grouped, layered electrode particles. When the electrode, anode or cathode, has been assembled with a porous separator, and an opposing electrode, and the pores of the electrode infiltrated with a suitable lithium ion-containing electrolyte, the two groupings of carbon black serve to enhance the electrochemical function of tie electrode and the cell in which it is used.

Other objects and advantages of the invention will be apparent from the following descriptions of preferred embodiments of practices of the invention.

### BRIEF DESCRIPTION OF THE DRAWINGS

FIG. 1 is an enlarged schematic illustration of the anode, separator, and cathode elements of a lithium-ion cell depicting an anode and a cathode, each consisting of a metal current collector carrying a porous layer of deposited particles of conductive carbon black/active electrode material formed in accordance with the two-step, carbon black coating process of this invention.

FIG. 2 is an enlarged, schematic illustration of the two-step process of this invention for applying and mixing aggregates of nanometer-size carbon black particles with particles of lithium battery cell electrode materials to form a distribution of carbon black particles on the surfaces of the electrode particles and small network clusters of carbon black particles between the particles of electrode materials.

FIG. 3 is a schematic illustration of a mixing container and mixing blades or tools for mixing liquid dispersions of aggregates of carbon black particles with particles of an electrode material.

### DESCRIPTION OF PREFERRED EMBODIMENTS

In accordance with processes of this invention, aggregates of nanometer-size carbon black particles are coated onto larger particles of active electrode materials in the making of electrodes for lithium battery cells. Micrometer size aggregates of nanometer size particles of carbon black are used in coating electrode materials for the purpose of improving electrochemical conductivity into and between particles of electrode materials in the presence of a suitable non-aqueous lithium ion-containing electrolyte. Carbon black is commercially available and is typically produced by incomplete combustion of heavy petroleum products. It is preferred to use carbon black particles that are, individually, about ten to one hundred nanometers in diameter, or largest dimension, and are initially clustered in aggregates that are about ten micrometers to about one hundred micrometers in diameter or largest characteristic dimension. Different commercial sources of carbon black are produced with varying BET surface areas. The BET surface area of the carbon black used in practices of this invention is suitably in the range of 10 m²/g to 1000 m²/g.

An illustrative lithium-ion cell will be described, in which electrode members can be prepared using practices of this invention.

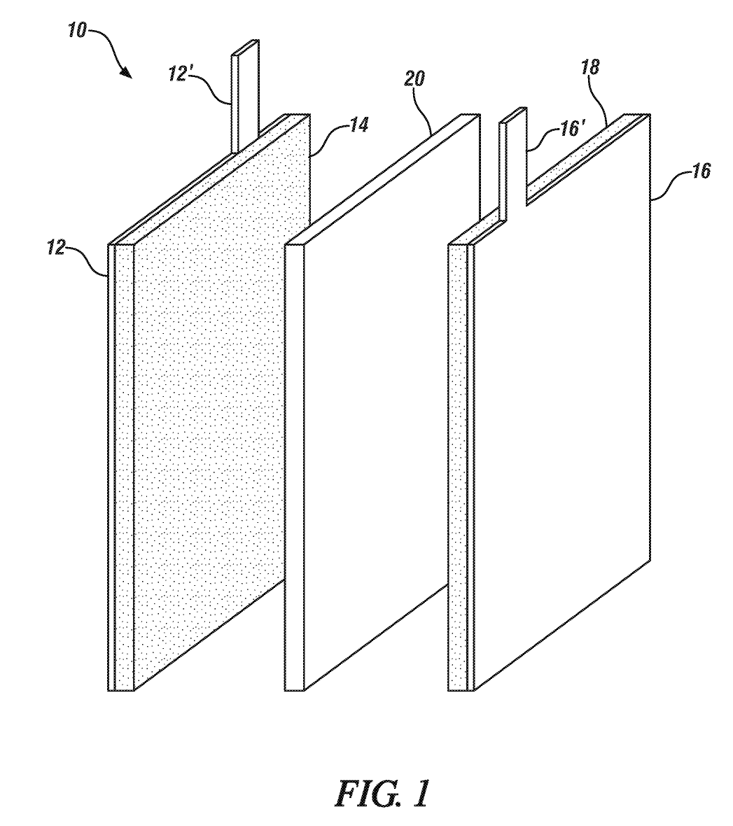

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification. Practices of this invention are typically used in the manufacture of electrode members of the lithium-ion cell when they are used in the form of relatively thin, layered structures.

In FIG. 1, a negative electrode comprises a relatively thin conductive metal foil current collector 12. In many lithium-ion cells, the negative electrode current collector 12 is suitably formed of a thin layer of copper or stainless steel. The thickness of metal foil current collector is suitably in the range of about five to twenty-five micrometers. The current collector 12 has a desired two-dimensional plan-view shape for assembly with other solid members of a cell. Current collector 12 is illustrated as rectangular over its principal surface, and further provided with a connector tab 12′ for connection with other electrodes in a grouping of lithium-ion cells to provide a desired electrical potential or electrical current flow.

Deposited on the negative electrode current collector 12 is a thin, porous layer of resin-bonded, porous particulate negative electrode material 14. Suitable negative electrode materials include, for example, graphite, lithium titanate (LTO), and silicon-based materials such as silicon, silicon alloys (including LiSi alloys), and SiOx. In accordance with practices of this invention, the particles of negative electrode material are twice-coated with nanometer-size particles of carbon black. As illustrated in FIG. 1, the layer of negative electrode material 14 is typically co-extensive in shape and area with the main surface of its current collector 12 and bonded to it. The electrode material has sufficient porosity to be infiltrated by a liquid, lithium-ion containing electrolyte. The thickness of the rectangular layer of negative electrode material may be up to about two hundred micrometers so as to provide a desired current and power capacity for the negative electrode. As will be further described, the negative electrode material may be applied so that one large face of the negative electrode material 14 is bonded to a maj or face of current collector 12 and the other large face of the negative electrode material layer 14 faces outwardly from its current collector 12.

A positive electrode is shown, comprising a positive current collector foil 16 (often formed of aluminum or stainless steel) and a coextensive, overlying, porous resin bonded layer of positive electrode material 18. Suitable positive electrode materials include, for example, lithium manganese nickel cobalt oxide (NMC). Examples of other positive electrode materials include lithium manganese oxide (LMO), lithium cobalt oxide (LCO), lithium nickel cobalt aluminum oxide (NCA), lithium iron phosphate (LFP), and other lithium metal oxides and phosphates. In accordance with practices of this invention the particles of positive electrode material are twice-coated with nanometer-size particles of carbon black.

Positive current collector foil 16 also has a connector tab 16′ for electrical connection with other electrodes in other cells that may be packaged together in the assembly of a lithium-ion battery. The positive current collector foil 16 and its coating of porous positive electrode material 18 are typically formed in a size and shape that are complementary to the dimensions of an associated negative electrode. In the illustration of FIG. 1, the two electrodes are alike in their shapes (but they do not have to be identical), and assembled in a lithium-ion cell with the major outer surface of the negative electrode material 14 facing the major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 5 to 25 micrometers. And the thicknesses of the electrode materials, formed by this two-step wet-mixing and coating process are up to about 200 micrometers. Again, in accordance with practices of this invention the particles of negative electrode material are twice coated with nanometer size particles of carbon black.

A thin porous separator layer 20 is interposed between the major outer face of the negative electrode material layer 14 and the major outer face of the positive electrode material layer 18. In many battery constructions, the separator material is a porous layer of a polyolefin, such as polyethylene or polypropylene. Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the negative and positive electrode material layers 14, 18, and is shaped and sized to serve this function. In the assembly of the cell, the opposing major outer faces of the electrode material layers 14, 18 are pressed against the major area faces of the separator membrane 20. A liquid electrolyte is injected into the pores of the separator membrane 20 and electrode material layers 14, 18.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and liquid solvent is selected for providing suitable mobility and transport of lithium ions in the operation of the cell. The electrolyte is carefully dispersed into and between closely spaced layers of the electrode elements and separator layers. The electrolyte is not illustrated in the drawing figure because it is difficult to illustrate between tightly compacted electrode layers.

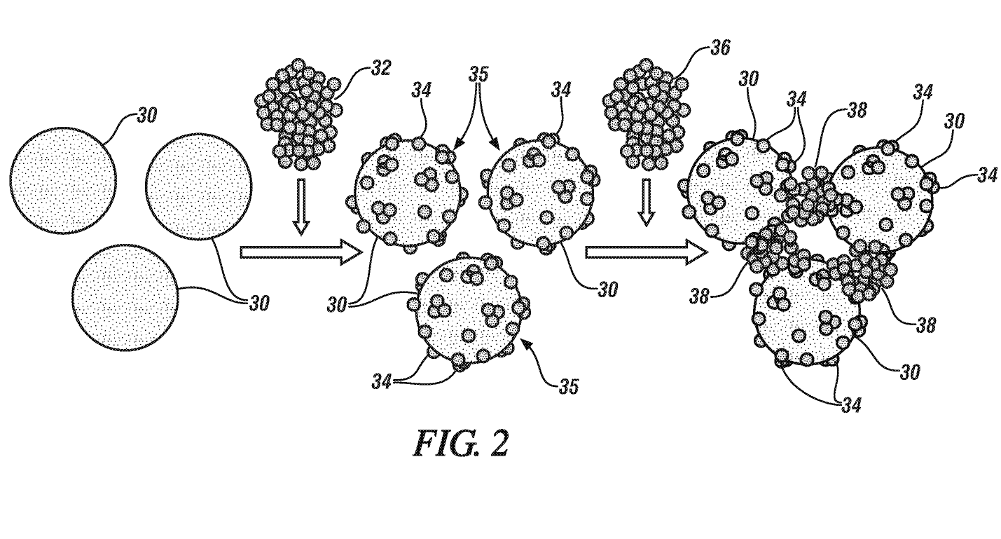

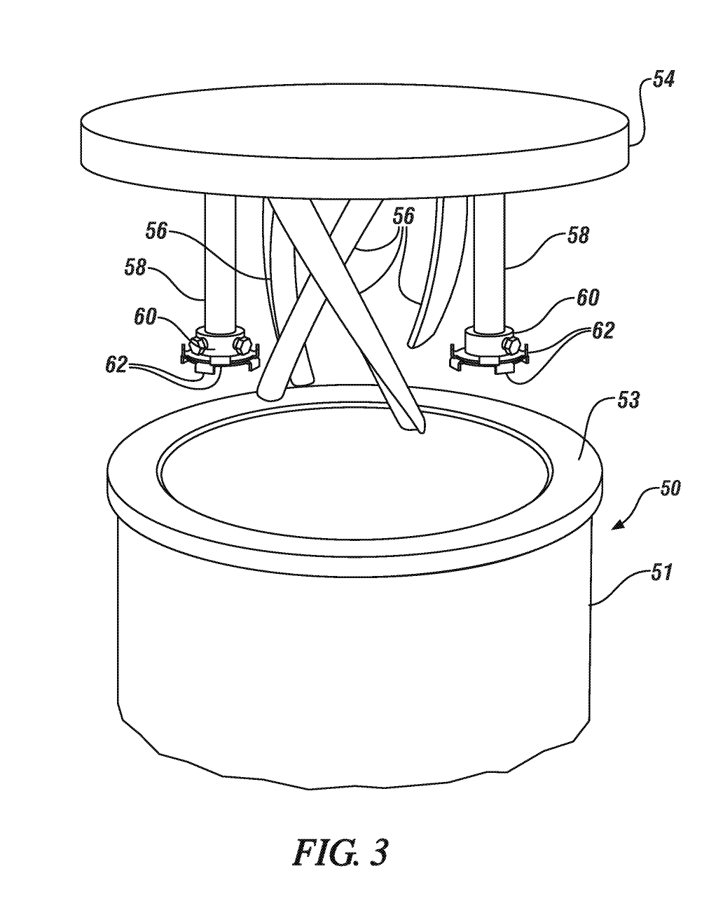

FIG. 2 is a schematic illustration of the subject two-step coating process of active electrode materials with carbon black materials and FIG. 3 is an illustration of a mixing container and stirring tools for performing the two-step coating process.

In this electrode making process, particles of a selected positive or negative electrode material are mixed and coated with particles of carbon black in the presence of liquid vehicle in a two-step mixing process. The liquid vehicle may sometimes be referred to as a solvent. It may be used to dissolve a small amount of polymeric binder material for subsequent bonding of the electrode particles. But the liquid is employed largely to enable and enhance the suspension and mixing of the electrode material particles and the particles of carbon black. The liquid is ultimately removed by evaporation from the particles at the completion of the processing, thereby depositing any dissolved binder material for the purpose of bonding a layer of the coated electrode particles in a porous bonded layer to a current collector substrate in the forming of the electrode. Such electrode constructions are illustrated in FIG. 1 of this specification.

In an illustrative example of the coating practices of this invention, particles of lithium nickel manganese cobalt oxide (NMC, a composite oxide) may be selected as a suitable positive electrode (or cathode) material. The NMC particles are prepared as generally spherically shaped and to have an average diameter of about ten micrometers within a suitably narrow range of diameters. A quantity of the particles is prepared for a desired sized batch of electrode material.

A total quantity of carbon black conductive additive is also determined based on the amount of electrode material to be coated. As stated, the carbon black is added in the form of micrometer-sized aggregates of nanometer-size particles of carbon black. Further, the aggregates of carbon black particles are added in two increments and employed to be deposited in different coating locations to enhance conductivity between the electrode particles. A first quantity of carbon black is mixed with the particles of electrode material to form a suitably uniform coating of carbon black particles on substantially each particle of the electrode material. Then, a second quantity of the carbon black aggregates are mixed with the coated electrode material particles to form an interconnected network of conductive carbon black particles at the interfaces of previously coated electrode particles. This two-step coating process is illustrated schematically in a greatly enlarged and simplified illustration of FIG. 2. For purposes of easier visualization, FIG. 2 does not show the liquid, which is used as a dispersant in both steps of the two step mixing process. And, for the same purpose, FIG. 2 illustrates the electrode particles much more spaced apart than they would be in the mixing steps of this invention.

Thus, in FIG. 2, a few electrode particles 30 (which could be NMC cathode particles) are shown. A first batch of aggregates 32 of carbon black particles is mixed with electrode particles 30 to form a coating of small clusters 34 of carbon black particles on the outer surfaces of each of the electrode particles 30. This coating may comprise small clusters of, for example, about two to ten individual carbon black particles. This representation is simplified in the illustration of FIG. 2. The initial aggregates 32 of carbon black particles may, for example, have largest dimensions of about 10 to 100 micrometers. But these initial aggregates 32 of many nanometer-size carbon black particles are broken down by the mixing process in forming the smaller clusters 34 of carbon black particles on the surfaces of the electrode material particles 30. These smaller clusters 34 of carbon black particles may, for example, comprise 2-10 particles, with the small clusters having sizes of about 100 to 500 nanometers. The composite 35 of small clusters 34 of carbon black particles on electrode particles 30 is then ready for a subsequent mixing step. As will be described in more detail, this first mixing step is conducted with vigorous mixing of a relatively viscous mixture of electrode particles, carbon black particles and a suitable liquid. This first mixing step for coating the individual electrode particles 30 with small clusters 34 of conductive carbon black particles is considered a “hard” mixing step. While the composite material 35 is retained in a mixing vessel, more liquid dispersant (not illustrated in FIG. 2) may be added to the composite 35 material.

After this first mixing step, a second mixing step is conducted with an addition of a second predetermined quantity of aggregates of carbon black particles 36 (and, typically, more liquid dispersant). In general it is preferred that the second batch of carbon black material be of the same composition and physical character as the first batch. But it is mixed with the composite 35 in a different way. The mixing is less vigorous, using a less viscous liquid-solid mixture and using less stirring force in the mixing device (not illustrated in FIG. 2, but a representative device is illustrated in FIG. 3). The mixing in the second step is conducted so as to place the second batch of carbon particle aggregates 36 as clusters 38 of carbon black particles at interfaces between the previously carbon black particle 34-coated particles of electrode material 30. These clusters 38 of carbon black particles at the electrode particle interfaces are larger than carbon black clusters 34 on the surfaces of the electrode particles 30. The clusters 38 of carbon black particles at electrode particle interfaces may have characteristic dimensions of, for example, about one to ten micrometers.

At the conclusion of the second mixing step, the mixture comprises particles of electrode material 30 with surface coatings of carbon black particles 34 and with clusters of carbon black particles 38 between the electrode particles 30. The mixture also comprises the liquid used in the two mixing steps. As described in more detail below in this specification, the mixture may also comprise a predetermined quantity of a binder resin for bonding the particles of electrode material to each other and to a surface of a metal current collector strip or foil. This liquid-containing, carbon-coated, electrode particle mixture may now be transferred for placement and spreading on a current collector surface.

The quantities of carbon black particles added to the electrode particles are suitably determined experimentally during preparations for the manufacture of one or many electrodes for the manufacture of lithium batteries. In general, the total quantity of carbon black added to particulate electrode material is about one percent to about ten percent by weight of the electrode material. About 30 to 60% by weight of the total carbon black content is added in the first mixing step to coat the electrode particles and the remainder is added in the second mixing step to form clusters at the interfaces of the electrode particles in the formed electrode.

Practices for conducting the two-step mixing process will be described in more detail with reference to FIG. 3 of the drawings. A predetermined quantity of particles of electrode material is added to a mixing container such as container 50 in FIG. 3. Before, during, or after addition of the particle to the mixing container, the electrode particles are mixed with a suitable liquid vehicle for the first mixing step with aggregates of carbon black particles. Preferably the mixing of the electrode particles with the liquid is performed in the mixing container. Water may be used as the liquid dispersant for the practice of this invention. An aqueous dispersible binder such as a combination of styrene-butadiene rubber and sodium carboxymethyl cellulose may be used in combination with water in the mixing process with carbon black. But when the making of the electrode is to include a polymeric binder such as polyvinylidene fluoride (PVDF), that is not readily dispersible in water, a suitable organic liquid may be used for the mixing process. Suitable liquids for an organic system include, for example, N-methyl-2-pyrrolidone, ethanol, propanol, hexane, acetone, and the like.

The amount of liquid vehicle is determined to accommodate the goal of the first mixing step with carbon black, which is to coat the surfaces of each of the micrometer-sized particles of electrode material (e.g., NMC cathode material) with nanometer-size particles of carbon black. The physical nature of the selected mixing device and the quantity of liquid dispersant are determined and selected to accomplish this goal using a relatively hard, viscous mixing process.

As seen in FIG. 3, commercially available mixing container 50 is a round stainless steel vessel with a flat bottom (not shown) that is sized to contain a predetermined amount of the liquefied electrode material to be coated. The round cylindrical side 51 is preferably jacketed (not shown) to provide for temperature control of the contents of the mixing vessel 50 using circulating water at a controlled temperature. Mixing container 50 may also have a valved outlet (not shown) in the bottom for removal of the final slurry of mixed electrode material particles and carbon black particles.

A mixing head 54 is employed carrying four downwardly-angled fixed mixing shafts 56 and two vertical, separately rotatable, mixing shafts 58, each with a stirring head 60 carrying six angled stirring blades 62. The mixing head houses a motor with associated drive mechanisms for propelling the four angled mixing shafts 56 at a common desired speed or rotation, and separately propelling the vertical mixing shafts 58 a desired speed of rotation for them. This versatile mixing head 54 is lowered in sealing engagement against the flat top surface of the upper surface 53 of the round mixing container 50 to seal the stirred contents within the container.

As an illustrative example, 100 parts by weight of particles of NMC cathode material is to be mixed with an initial quantity of 5 parts by weight of aggregates of carbon black nanometer size particles. An amount of water in the range of about ten to thirty weight percent of the 105 parts by weight of the total solids is used in the mixing process. In other words, it is often desired to have a solids' content of about seventy percent by weight or higher in this first “hard” mixing step. If a binder is to be used in forming the cathode, a few parts by weight of water-soluble binder may be dissolved in the water. The binder may be dissolved in the dispersant liquid in either or both mixing steps.

In this first mixing step, the four angled mixing shafts 56 may be rotated at a rate of about ten to one hundred revolutions per minute. The higher speed vertical mixing shafts 58 which rotate mixing blades 62 may be turned off or rotated at a speed of less than 1000 rpm. Thus, the mixing tools are employed to stir and mix the relatively viscous mixture of NMC particles, carbon black particles, and water (including any dissolved binder). The rate of rotation of the six mixing shafts 56, 58 and the duration of rotation is determined to coat the particles of NMC with carbon black particles to produce the composite particles 35 as illustrated in FIG. 2. The first mixing step may start with the liquid dispersed particles at a room temperature or ambient temperature. As the mixing proceeds, the temperature of the viscous mix may increase from room temperature to a temperature in the range of, for example, 60° C. to 80° C. In many instances it is desirable to maintain the temperature of the stirred materials at a temperature of 60° C. or lower during the first mixing step. Often, a mixing time of several minutes to a few hours is required depending on the viscosity of the wet mixture and the mechanical structure of the selected mixing device. The mixing operation may be temporarily interrupted from time-to-time to remove representative samples from the contents of vessel 50 for examination of the state of mixing.

Following completion of the first mixing step, an additional quantity of aggregates of carbon black particles and an additional quantity of the liquid is added to the first-stage mixture in the container 50. For example, an additional 3 parts by weight of the carbon black is added. And an additional amount of water is added to reduce the solids content of the mixture to about forty to seventy weight percent of the total of solids (including binder) and liquid. In this softer, less viscous, mixing step, the goal is to disperse the added, nanometer-size, carbon black particles as clusters of particles at the interfaces of the electrode material particles as illustrated by the locations and appearance of clusters 38 in FIG. 2. Again, if desired, a suitable amount of binder material may be dissolved in the water added to the electrode material. Polymeric binder material is typically added in an amount of about 1-5 w% of the electrode material.

In this second mixing step, the vertical shafts 58 (with blades 62) may be rotated at from 2000 to about 20,000 rpm, and the angled shafts 56 are rotated at from 10 to 100 rpm. Following the incorporation of the additional liquid and carbon black into the first mixing stage material, the temperature typically decreases (to, e.g., 40-50° C.). Further cooling of the mixture may not be required. The rates of rotation of the selected mixing shafts and the durations of rotation are determined to place clusters of carbon black particles at the interfaces of the electrode particles as described and illustrated in FIG. 2. Often, a mixing time of several minutes to a few hours is required depending on the viscosity of the wet mixture and the mechanics of the selected mixing device. The mixing operation may be temporarily interrupted from time-to-time to remove representative samples from the contents of vessel 50 for examination of the state of mixing.

At the completion of the two-step mixing process, a wet mixture of electrode particles is obtained in which individual electrode particles are coated with carbon black particles and other carbon black particles are clustered between the electrode particles. The wet or liquid-containing mixture is removed from the mixing container. The liquid-content, or some portion of it, may be retained in the particle mixture and the flow able or moldable mixture applied in a layer to one or both major flat surfaces of a current collector strip or foil. After the liquid-containing electrode material has been applied to surfaces of one or more current collectors, an evaporation process may be conducted to remove much or all of the liquid to leave a porous layer of particles of electrode material coated with smaller particles of carbon black and containing clusters of carbon black particles at interfaces of the electrode particles. If a binder material has been dissolved in the dispersant liquid, a suitably small amount of binder material is deposited on the particles of active material as the evaporation of the liquid progresses. Suitably a layer of thus-coated electrode particles are bonded to each other and to a surface of a metallic current collector in a thickness up to about two hundred micrometers.

In an assembled lithium battery cell containing such carbon black particle-coated electrode particles, the mixed particles will be infused with a liquid, lithium-ion containing, electrolyte. And the conductive carbon black particles, as placed on the electrode particles by the described two-step mixing process, will enable fuller utilization of the electrode particles to increase the available power of a given amount of electrode material, and will lengthen the operating life of the electrode and cell. Practices of the invention have been described and illustrated using some illustrative examples which are not limitations of the scope of the claimed invention.

1. A method of making an anode or a cathode for a lithium battery cell, the method comprising:
mixing a predetermined quantity of particles of an active electrode material for an anode or for a cathode of a lithium battery cell with a first predetermined quantity of aggregates of nanometer size carbon black particles, the particles of electrode material having shapes that permit them to be deposited in a porous layer of inter-touching particles with interfacial spacing between surface portions of the electrode material particles, the mixing being performed with the electrode material particles and carbon black particles being dispersed in a liquid that is un-reactive with the particles, the particles and the liquid being contained for mixing of the particles using a mechanical mixing tool, the quantity of the liquid and the mechanical intensity and duration of the mixing being controlled to uniformly disperse the first quantity of carbon black particles on the surfaces of the active electrode material particles in a first stage mixture;
adding a second predetermined quantity of aggregates of nanometer size carbon black particles and an additional quantity of liquid to the contained first stage mixture and using a mechanical mixing tool, while controlling the intensity and duration of mixing, to disperse the second quantity of carbon black particles in the interfacial spaces between the particles of active electrode material in a second stage mixture; and then, while retaining at least some of the liquid in the second stage mixture
applying the second stage mixture of particles of electrode material and particles of carbon black in a layer of electrode material to a surface of a metal current collector for the electrode, and bonding the particles of the electrode material to each other and to the surface of the current collector, and removing a desired portion of the liquid from the mixture of particles, the layer of electrode material being characterized by particles of electrode material with surfaces coated with particles of carbon black and with carbon black particles occupying interfacial spaces between the particles of electrode material, the overall content and locations of carbon black particles providing enhanced electrochemical conductivity in the porous electrode layer in the presence of a lithium-containing electrolyte within the pores of electrode material.

2. A method of making an anode or a cathode for a lithium battery cell as recited in claim 1 in which the particles and liquid are contained in a mixing container with two or more rotating mixing tools and the rotating mixing tools are used at first mixing rate schedule for the first mixing step and at a different mixing rate schedule for the second mixing step.

3. A method of making an anode or a cathode for a lithium battery cell as recited in claim 1 in which the particles and liquid are contained in a round cylindrical mixing container, and a combination of rotational mixing tools with a first combination of rates of rotation and duration of rotation is used for the first mixing step and a second and different combination of rates of rotation and duration of rotation is used for the second mixing step.

4. A method of making an anode or a cathode for a lithium battery cell as recited in claim 1 in which the liquid is water.

5. A method of making an anode or a cathode for a lithium battery cell as recited in claim 1 in which the liquid is an organic composition that is liquid during the mixing steps.

6. A method of making an anode or a cathode for a lithium battery cell as recited in claim 1 in which the starting aggregates of carbon black particles have characteristic dimensions in the range of about ten micrometers to about one hundred micrometers.

7. A method of making an anode or a cathode for a lithium battery cell as recited in claim 1 in which the particles of electrode material have characteristic dimensions in the range of about five micrometers to about fifty micrometers.

8. A method of making an anode or a cathode for a lithium battery cell as recited in claim 1 in which the carbon black particles have diameters or characteristic dimensions in the range of about ten to one hundred nanometers and the carbon black particles are dispersed on the surfaces of the active material particles, in the first stage mixture, as clusters of carbon black materials having characteristic dimensions of about one hundred nanometers to about five hundred nanometers.

9. A method of making an anode or a cathode for a lithium battery cell as recited in claim 1 in which the carbon black particles have diameters or characteristic dimensions in the range of about ten to one hundred nanometers and the carbon black particles are dispersed in interfacial spaces between the active material particles, in the second stage mixture, as clusters of carbon black materials having characteristic dimensions of about one micrometer to about ten micrometers

10. A method of making an anode as recited in claim 1 in which the particulate electrode material is at least one of graphite, lithium titanate, and a silicon-based composition, and the current collector is copper.

11. A method of making a cathode as recited in claim 1 in which the electrode material is an oxide compound or a phosphate compound of lithium and one or more additional metal elements, and the current collector is aluminum.

12. A method of making a cathode as recited in claim 1 in which the electrode material is at least one of lithium nickel manganese cobalt oxide, lithium manganese oxide, lithium cobalt oxide, lithium nickel cobalt aluminum oxide, and lithium iron phosphate, and the current collector is aluminum.

13. A method of making an anode or a cathode for a lithium battery cell as recited in claim 1 in which the first mixing step is started with the particles and liquid at an ambient temperature and the mixture is cooled during the first mixing step to maintain the mixture below a predetermined temperature.

14. A method of making an anode or a cathode for a lithium battery cell, the method comprising:
mixing a predetermined quantity of particles of an active electrode material for an anode or for a cathode of a lithium battery cell with a first predetermined quantity of aggregates of nanometer size carbon black particles, the particles of electrode material having characteristic dimensions in the range of about five to fifty micrometers and shapes that permit them to be deposited in a porous layer of inter-touching particles with interfacial spacing between surface portions of the electrode material particles, the mixing being performed with the electrode material particles and carbon black particles being dispersed in a liquid that is un-reactive with the particles, the particles and the liquid being contained for mixing of the particles using a mechanical mixing tool, the quantity of the liquid and the mechanical intensity and duration of the mixing being controlled to uniformly disperse the first quantity of carbon black particles on the surfaces of the active electrode material particles in a first stage mixture, the carbon black particles being dispersed as individual particles or clusters of two to ten carbon black particles on surfaces of the active electrode material particles;
adding a second predetermined quantity of aggregates of nanometer size carbon black particles and an additional quantity of liquid to the contained first stage mixture and using a mechanical mixing tool while controlling the intensity and duration of mixing to disperse the second quantity of carbon black particles in spaces between the particles of active electrode material in a second stage mixture, the second quantity of carbon black particles being dispersed in clusters of particles having characteristic dimensions in the range of about one to ten micrometers; and then, while retaining at least some of the liquid in the second stage mixture
applying the second stage mixture of particles of electrode material and particles of carbon black in a layer of electrode material to a surface of a metal current collector for the electrode, and bonding the particles of the electrode material to each other and to the surface of the current collector, and removing a desired portion of the liquid from the mixture of particles, the layer of electrode material being characterized by particles of electrode material with surfaces coated with particles of carbon black and with carbon black particles occupying spaces between the particles of electrode material, the overall content and locations of carbon black particles providing enhanced electrochemical conductivity in the porous electrode layer in the presence of a lithium-containing electrolyte within the pores of electrode material.

15. A method of making an anode or a cathode for a lithium battery cell as recited in claim 14 in which the liquid is water.

16. A method of making an anode or a cathode for a lithium battery cell as recited in claim 14 in which the liquid is an organic composition that is liquid at the ambient temperature of the mixing steps.

17. A method of making an anode as recited in claim 14 in which the particulate electrode material is at least one of graphite, lithium titanate, and a silicon-based composition, and the current collector is copper.

18. A method of making a cathode as recited in claim 14 in which the electrode material is an oxide compound or a phosphate compound of lithium and one or more additional metal elements, and the current collector is aluminum.

19. A method of making a cathode as recited in claim 14 in which the electrode material is at least one of lithium nickel manganese cobalt oxide, lithium manganese oxide, lithium cobalt oxide, lithium nickel cobalt aluminum oxide, and lithium iron phosphate, and the current collector is aluminum.

20. A method of making an anode or a cathode for a lithium battery cell as recited in claim 14 in which the first mixing step is started with the particles and liquid at an ambient temperature and the mixture is cooled during the first mixing step to maintain the mixture below a predetermined temperature.
